(19) United States
(12) Patent Application Publication
(10) Pub. No.: US 2025/0370082 A1
(43) Pub. Date: Dec. 4, 2025

(54) LOCATION SERVICES BASED ON USE OF COUNTRY CODE

(71) Applicant: QUALCOMM Incorporated, San Diego, CA (US)

(72) Inventor: Avinash SHRIVASTAVA, Hyderabad (IN)

(21) Appl. No.: 18/680,709

(22) Filed: May 31, 2024

(51) Int. Cl. G01S 5/02; H04W 4/029; H04W 64/00

(52) U.S. Cl. CPC G01S 5/021; G01S 5/0295; H04W 4/029; H04W 64/00

(57) ABSTRACT

An example method performed by a user equipment for generating and transmitting a capability report to a location server can include identifying a first country in which the user equipment is camped and identifying, based at least in part on the identified first country, a first GNSS that is preferred for use by the user equipment. The method can further include the user equipment generating the capability report and including in the capability report, an indication of preference by the user equipment for use of the first GNSS. The method can further include transmitting the capability report to the location server in a control plane call flow according to a long term evolution positioning protocol (LPP). A UE that is configured to use a preferred GNSS may provide various cost benefits and advantages such as in the form of eliminating unnecessary/unused hardware and software.

### BACKGROUND

### Field of Disclosure

The present disclosure relates generally to the field of position determination, and more specifically to communications between a user equipment and a location server for performing position determination operations.

### Description of Related Art

Position determination operations may be performed by various types of devices that can be generally referred to as user equipment (UE), for purposes of determining a position of the UE. In one case, the UE may determine its position based on receiving signals from multiple satellites of a global navigation satellite system (GNSS) such as global position system (GPS). In another case, the UE may seek help from one or more other devices for determining a position of the UE. The other devices can be one or more network elements that are a part of a wireless network such as, for example, a 5G cellular network that operates in conformance with a fifth-generation (5G) technology standard. In this case, communications between the UE and the network element(s) may also conform to various standards. Some of the messages involved in such communications are messages that convey information pertaining to various aspects of a position determination procedure.

### BRIEF SUMMARY

Methods and techniques are described herein to enable a user equipment (UE) to perform a location determination operation based on use of one or more messages containing information associated with items such as, for example, a country in which the UE is camped at the time of performing the location determination operation and/or a preference for use of a specific global navigation satellite system (GNSS) by the UE.

An example method performed by a user equipment for generating and transmitting a capability report to a location server can include identifying a first country in which the user equipment is camped; identifying, based at least in part on the identified first country, a first GNSS that is preferred for use by the user equipment; generating the capability report, the capability report including an indication of preference by the user equipment for use of the first GNSS; and transmitting the capability report to the location server in a control plane call flow according to a long term evolution positioning protocol (LPP).

An example user equipment configured to generate and transmit a capability report to a location server, the user equipment can include one or more transmitters, at least one memory, and one or more processors communicatively coupled with the one or more transmitters and the at least one memory. The one or more processors are configured to identify a first country in which the user equipment is camped; identify, based at least in part on the identified first country, a first GNSS that is preferred for use by the user equipment; generate the capability report that includes an indication of preference by the user equipment for use of the first GNSS; and transmit the capability report via the one or more transmitters, to the location server, in a control plane call flow according to a long term evolution positioning protocol (LPP).

An example location server for providing location assistance data to one or more user equipment, the location server can include one or more transmitters; one or more receivers; at least one memory; and one or more processors communicatively coupled with the one or more transmitters, the one or more receivers, and the at least one memory. The one or more processors are configured to receive, via the receiver, from a first user equipment, an indication of preference for use of a first global navigation satellite system (GNSS) by the first user equipment; generate, based at least in part on the indication of preference received from the first user equipment, location assistance data for use of the first GNSS by the first user equipment for performing one or more GNSS positioning operations and excluding use of other GNSS by the first user equipment for performing the one or more GNSS positioning operations; and transmit, via the transmitter, to the first user equipment, the location assistance data that is focused exclusively upon the first GNSS.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

An understanding of the nature and advantages of various embodiments may be realized by reference to the following figures.

FIG. 1 shows a diagram of a communication system that can provide location services support to one or more user equipments.

FIG. 2 is a simplified diagram of a GNSS system.

FIG. 3 is a diagram of GNSS frequency bands that may be used by GNSS receivers.

FIG. 4 shows a table that indicates various GNSS systems operating in various countries.

FIG. 5 shows an example scenario where a UE communicates with a location server for performing positioning operations.

FIG. 6 shows a flow diagram of a method performed by a user equipment for generating and transmitting a capability report to a location server.

FIG. 7 illustrates some example functional components of an example UE that can include a GNSS receiver in accordance with the disclosure.

FIG. 8 shows a block diagram of various hardware components of a location server according to an embodiment.

Like reference numbers and symbols in the various figures indicate like elements, in accordance with certain example implementations. In addition, multiple instances of an element may be indicated by following a first number for the element with a letter or with a hyphen and a second number. For example, multiple instances of an element 110 may be indicated as 110-1, 110-2, 110-3 etc. When referring to such an element using only the first number, any instance of the element is to be understood (e.g. elements 110 in the previous example would refer to elements 110-1, 110-2 and 110-3.

### DETAILED DESCRIPTION

Various aspects described herein generally relate to methods and techniques that enable a user device to perform various types of location determination operations based on use of one or more messages containing information associated with a country in which the UE is camped at the time of performing a location determination operation and/or a preference for use of a specific global navigation satellite system (GNSS) by the UE. The location determination operation may be associated with a UE that communicates with one or more network entities, such as, for example, with a server that is configured to provide a location management function (LMF). The communications may be carried out, for example, by use of the LTE Positioning Protocol (LPP) defined in 3GPP TS 36.355 and TS 37.355. Here, LPP messages may be transferred between the UE and the LMF via a server that is configured to provide an Access and Mobility Management Function and a serving (AMF) and a serving gNB for the UE. Further details pertaining to the UE, LMF, AMF, and gNB are provided below.

In a traditional control plane (CP)-based location solution, a call flow does not include messages that include information associated with items such as, for example, a mobile country code (MCC), a mobile network code (MNC), a preference for use of a specific GNSS system by a UE, etc., because call flows using CP protocols are typically dedicated to the transfer of signaling information. With user plane (UP) location, signaling related to positioning and support of positioning may be carried as part of data by use of other protocols such as IP, TCP, UDP, and TCP/IP. Here again, a call flow does not include messages containing information associated with items such as, for example, an MCC, an MNC, and/or a preference for use of a specific GNSS system by a UE.

The lack of such information in traditional practice is disadvantageous for various reasons such as, for example, unnecessary hardware cost, software implementation costs, software execution costs, and costs associated with use of GNSS systems owned and operated by multiple entities.

The various embodiments described herein pertain to conveying certain types of information via a call flow such as, for example, a call flow formatted in a long term evolution positioning protocol (LPP). The information can include, for example, a preferred GNSS, an MCC, an MCN, and/or a public land mobile network (PLMN) code. Such information may be used to optimize a configuration of a UE and/or location server (LS), such as, for example, to eliminate/disable some hardware and/or software features of the UE and/or the LS.

Particular aspects of the subject matter described in this disclosure can be implemented to realize one or more of the following potential advantages and benefits.

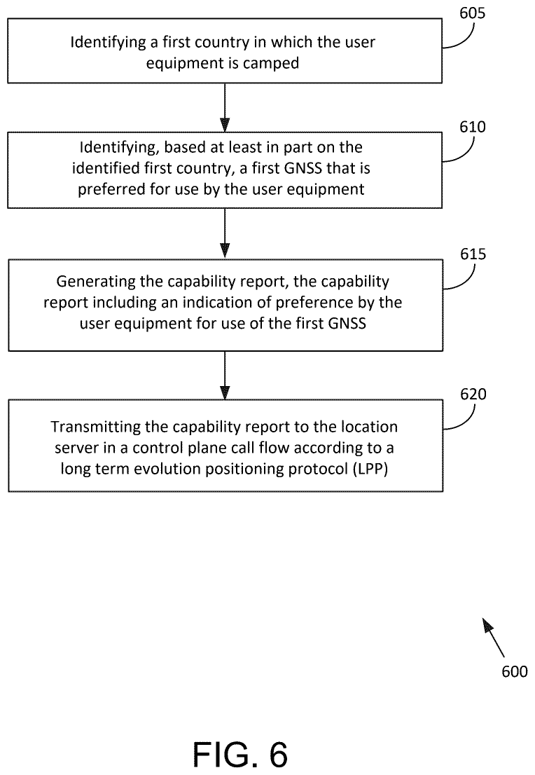

A first benefit that can be derived by use of an example method described below with reference to FIG. 6 (and other figures) and pertaining to UE operations. In accordance with the disclosure, a UE that is configured to use a preferred GNSS and eliminate use of at least one other GNSS, may offer various cost benefits and advantages. Cost benefits may be provided in the form of eliminating unnecessary/unused hardware and software. For example, in the case of a UE located in the US, hardware/software related to use of GNSS systems other than a preferred GNSS system (GPS, for example), such as, for example, use of Beidou, NavIC and QZSS, can be eliminated, thereby providing cost benefits. In another case, the UE located in the US may include hardware/software related to use of the L1 GPS band as well as the L5 GPS band. However, costs associated with licensing fees, for example, may render the use of the L5 GPS band unattractive in terms of cost. Identifying and using the L1 GPS band as a preferred GNSS system eliminates the need for the UE to perform operations associated with L5 GPS signals for location determination and further eliminates the need for an LMF to provide the UE with assistance data associated with L5 GPS.

Eliminating the need for the LMF to provide the UE with such unnecessary content in the assistance data allows the LMF to generate assistance data in the form of curated assistance data or customized assistance data. Curated assistance data can include a GNSS support list that includes the preferred GNSS and omits other GNSS systems.

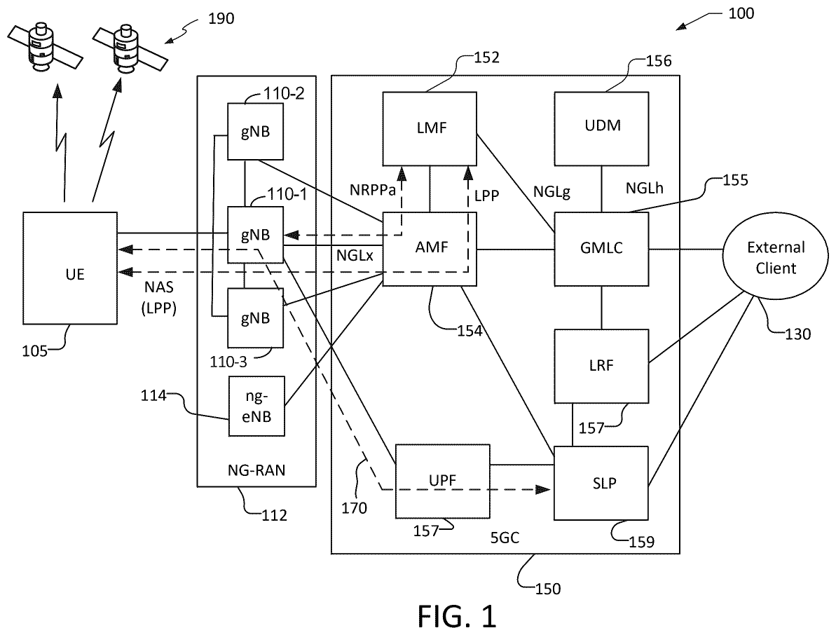

FIG. 1 shows a diagram of a communication system 100, that can provide location services support to one or more user equipment (UEs). Here, the communication system 100 includes a UE 105 and components of a Fifth Generation (5G) network. The example components of the 5G network include a Next Generation RAN (NG-RAN) 112 and a 5G Core Network (5GCN) 150. NG-RAN 112 plus 5GCN 150 may comprise a 5G System (SGS) (also referred to as 5G network), which may also be referred to as a New Radio (NR) network. NG-RAN 112 may also be referred to as a 5G RAN or as an NR RAN; and 5GCN 150 may be referred to as an NG Core network (NGC). The NG-RAN 112 and the 5GCN 150 may be part of a Visited Public Land Mobile Network (VPLMN) that is a serving network for the UE 105 or may be part of a Home Public Land Mobile Network (HPLMN) for UE 105. When functioning as a VPLMN, there may be a separate HPLMN for the UE 105 (not shown in FIG. 1) that communicates with the 5GCN 150 (e.g. via the Internet).

The communication system 100 may further utilize information from space vehicles (SVs) 190 for a Global Navigation Satellite System (GNSS) like the Global Positioning System (GPS), GLONASS, Galileo, Beidou or some other local or regional Satellite Positioning System (SPS) such as IRNSS, EGNOS or WAAS. Additional aspects pertaining to the use of GNSS for location determination are described below.

It should be noted that FIG. 1 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the communication system 100. Similarly, the communication system 100 may include a larger or smaller number of SVs 190, gNBs 110, external clients 150, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G network, similar network implementations and configurations may be used for other communication technologies, such as 3G, Long Term Evolution (LTE), IEEE 802.11 WiFi (also referred to as Wi-Fi) etc.

The UE 105 may comprise any electronic device configured for wireless communications. The UE 105 may be referred to as a device, a wireless device, a mobile terminal, a terminal, a mobile station (MS), a mobile device, or by some other name and may correspond to (or be part of) a smart watch, digital glasses, fitness monitor, smart car, smart appliance, cellphone, smartphone, laptop, tablet, PDA, tracking device, control device, or some other portable or moveable device. A UE 105 may comprise a single entity or may comprise multiple entities such as in a personal area network where a user may employ audio, video and/or data I/O devices and/or body sensors and a separate wireline or wireless modem.

Typically, though not necessarily, a UE 105 may support wireless communication with one or more types of Wireless Wide Area Network (WWAN) such as a WWAN supporting Global System for Mobile Communications (GSM), Code Division Multiple Access (CDMA), Wideband CDMA (WCDMA), Long Term Evolution (LTE), Narrow Band Internet of Things (NB-IoT), Enhanced Machine Type Communications (eMTC) also referred to as LTE category M1 (LTE-M), High Rate Packet Data (HRPD), 5G New Radio (NR), WiMax, etc. 5GCN 150 combined with NG-RAN 112 may be an example of a WWAN.

UE 105 may also support wireless communication with one or more types of Wireless Local Area Network (WLAN) such as a WLAN supporting IEEE 802.11 WiFi (also referred to as Wi-Fi) or Bluetooth® (BT).

UE 105 may also support communication with one or more types of wireline network such as by using a Digital Subscriber Line (DSL) or packet cable for example.

An estimate of a location of a UE 105 may be referred to as a location, location estimate, location fix, fix, position, position estimate or position fix, and may be geodetic, thereby providing location coordinates for the UE 105 (e.g., latitude and longitude) which may or may not include an altitude component (e.g., height above sea level, height above or depth below ground level, floor level or basement level).

Alternatively, a location of the UE 105 may be expressed as a civic location (e.g., as a postal address or the designation of some point or small area in a building such as a particular room or floor). A location of a UE 105 may also include an uncertainty and may then be expressed as an area or volume (defined either geodetically or in civic form) within which the UE 105 is expected to be located with some given or default probability or confidence level (e.g., 67% or 95%). A location of a UE 105 may further be an absolute location (e.g. defined in terms of a latitude, longitude and possibly altitude and/or uncertainty) or may be a relative location comprising, for example, a distance and direction or relative X, Y (and Z) coordinates defined relative to some origin at a known absolute location or some previous location of UE 105. In the description contained herein, the use of the term location may comprise any of these variants unless indicated otherwise. Measurements (e.g. obtained by UE 105 or by another entity such as gNB 110-1) that are used to determine (e.g. calculate) a location estimate for UE 105 may be referred to as measurements, location measurements, location related measurements, positioning measurements or position measurements and the act of determining a location for the UE 105 may be referred to as positioning of the UE 105 or locating the UE 105.

The UE 105 may enter a wireless connected state with communication system 100 that may include the NG-RAN 112 and 5GCN 150. In one example, UE 105 may communicate with a cellular communication network by transmitting wireless signals to, and/or receiving wireless signals from, a cellular transceiver, such as NR Node B (gNB 110-1) in the NG-RAN 112. The NG-RAN 112 may include one or more additional gNBs 110-2. The gNB 110-1 provides user plane and control plane protocol terminations toward the UE 105. The gNB 110-1 may comprise a serving gNB for UE 105 and may also be referred to as a base station, a base transceiver station, a radio base station, a radio transceiver, a radio network controller, a transceiver function, a base station subsystem (BSS), an extended service set (ESS), or by some other suitable terminology. The UE 105 also may transmit wireless signals to, or receive wireless signals from, a local transceiver (not shown in FIG. 1), such as an access point (AP), femtocell, Home Base Station, small cell base station, Home Node B (HNB) or Home gNB (HgNB), which may provide access to a wireless local area network (WLAN, e.g., IEEE 802.11 network), a wireless personal area network (WPAN, e.g., Bluetooth network) or a cellular network (e.g. an LTE network or other wireless wide area network such as those discussed in the next paragraph). Of course, it should be understood that these are merely examples of networks that may communicate with a mobile device over a wireless link, and claimed subject matter is not limited in this respect.

Examples of network technologies that may support wireless communication include GSM, CDMA, WCDMA, HRPD, eMTC and 5G NR. NB-IoT, GSM, WCDMA, LTE, eMTC and NR, which are technologies defined by 3GPP. CDMA and HRPD are technologies defined by the 3rd Generation Partnership Project 2 (3GPP2). Cellular transceivers, such as gNBs 110-1 and 110-2, may comprise deployments of equipment providing subscriber access to a wireless telecommunication network for a service (e.g., under a service contract). Here, a cellular transceiver may perform functions of a cellular base station in servicing subscriber devices within a cell determined based, at least in part, on a range at which the cellular transceiver is capable of providing access service.

Base stations (BSs) in the NG-RAN 112 shown in FIG. 1 comprise NR Node Bs, also referred to as gNBs, 110-1 and 110-2 (collectively and generically referred to herein as gNBs 110). Pairs of gNBs 110 in NG-RAN 112 may be connected to one another—e.g. directly as shown in FIG. 1 or indirectly via other gNBs 110. Access to the 5G network is provided to UE 105 via wireless communication between the UE 105 and one or more of the gNBs 110, which may provide wireless communication access to the 5GCN 150 on behalf of the UE 105 using 5G NR. 5G NR radio access may also be referred to as NR radio access or as 5G radio access. In FIG. 1, the serving gNB for UE 105 is assumed to be gNB 110-1, although other gNBs (e.g. gNB 110-2) may act as a serving gNB if UE 105 moves to another location or may act as a secondary gNB to provide additional throughout and bandwidth to UE 105.

Base stations (BSs) in the NG-RAN 112 shown in FIG. 1 may also or instead include a next generation evolved Node B, also referred to as an ng-eNB 114. ng-eNB 114 may be connected to one or more gNBs 110 in NG-RAN 112—e.g. directly or indirectly via other gNBs 110 and/or other ng-eNBs. An ng-eNB 114 may provide LTE wireless access and/or evolved LTE (eLTE) wireless access to UE 105. Some gNBs 110 (e.g. gNB 110-2) and/or ng-eNB 114 in FIG. 1 may be configured to function as positioning-only beacons, which may transmit signals (e.g. PRS signals) and/or may broadcast assistance data to assist positioning of UE 105 but may not receive signals from UE 105 or from other UEs. It is noted that while only one ngeNB 114 is shown in FIG. 1, some embodiments may include multiple ng-eNBs 114.

As noted, while FIG. 1 depicts nodes configured to communicate according to 5G communication protocols, nodes configured to communicate according to other communication protocols, such as, for example, the LTE protocol for an Evolved Universal Mobile Telecommunications System (UMTS) Terrestrial Radio Access Network (E-UTRAN) or IEEE 801.11 WiFi, may be used. For example, in a 4G Evolved Packet System (EPS) providing LTE wireless access to UE 105, a RAN may comprise an E-UTRAN, which may comprise base stations comprising evolved NodeBs (eNBs) supporting LTE wireless access. A core network for EPS may comprise an Evolved Packet Core (EPC). An EPS may then comprise an E-UTRAN plus EPC, where the E-UTRAN corresponds to NG-RAN 112 and the EPC corresponds to 5GC 150 in FIG. 1. Nodes configured to communicate using different protocols, may be controlled, at least in part, by the 5GCN 150. Thus, the NG-RAN 112 may include any combination of gNBs 110, ng-eNBs 114, or other types of base stations or access points.

The gNB s 110 and ng-eNB 114 can communicate with an Access and Mobility Management Function (AMF) 154, which, for positioning functionality, communicates with a Location Management Function (LMF) 152. The AMF 154 may support access and registration by the UE 105, mobility of the UE 105, including cell change and handover and may participate in supporting a signaling connection to the UE 105 and possibly helping establish and release Protocol Data Unit (PDU) sessions for UE 105. Other functions of AMF 154 may include: termination of a control plane (CP) interface from NG-RAN 112; termination of Non-Access Stratum (NAS) signaling connections from UEs such as UE 105; NAS ciphering and integrity protection; registration management; connection management; reachability management; mobility management; transport of Short Message Service (SMS) messages between UE 105 and an SMS Function (SMSF) (not shown in FIG. 1); access authentication and authorization.

The LMF 152 may support positioning of the UE 105 when UE 105 accesses the NG-RAN 112 and may support position procedures/methods such as Assisted GNSS (A-GNSS), Downlink Time Difference of Arrival (DL-TDOA), UL-TDOA, Real Time Kinematic (RTK), Precise Point Positioning (PPP), Differential GNSS (DGNSS), Enhanced Cell ID (ECID), UL-AOA, DL-AOD, round trip signal propagation time (RTT), multi-cell RTT (multi-RTT), WLAN positioning and/or other position methods. The LMF 152 may be connected to AMF 154 and/or to the Gateway Mobile Location Center (GMLC) 155. The LMF 152 may also process location services requests for the UE 105, e.g., received from the AMF 154 or from the GMLC 155. In some embodiments, a node/system that can implement the LMF 152 may additionally or alternatively implement other types of location-support modules, such as an Enhanced Serving Mobile Location Center (E-SMLC) or a Secure User Plane Location (SUPL) Location Platform (SLP). It is noted that in some embodiments, at least part of the positioning functionality (including derivation of the location of UE 105) may be performed at the UE 105 (e.g., using signal measurements obtained by UE 105 for signals transmitted by wireless nodes such as gNBs 110, and assistance data provided to the UE 105, e.g. by LMF 152 or gNB 110-1).

To assist references to different interfaces and show correspondence to the EPC CP location solution defined in 3GPP TS 23.271, an example interface labelled as NGLx can correspond to an interface SLx for EPC (e.g. with NGLg corresponding to SLg for EPC). Some interfaces may support control plane signaling and may be associated with control plane protocols that are used over one or more of the interfaces to support the control plane signaling. For example, a control plane protocol similar to or the same as the EPC LCS Protocol (ELP) defined in 3GPP TS 29.172 may be used between the LMF 152 and the GMLC 155 over an NGLg interface; a control plane protocol similar to the NAS Protocol defined in 3GPP TS 24.301 may be used between AMF 154 and a UE 105 and possibly between LMF 152 and AMF 154 over an NGLs interface; a CP NG Application Protocol (NGAP) defined 3GPP TS 38.413 may be used between AMF 154 and gNB 110 or ng-eNB 114 over an N2 interface; a CP LPP or NPP protocol may be used between UE 105 and LMF 152; and a CP supplementary service protocol (SSP, e.g. as defined in 3GPP TS 24.080) may be used between UE 105 and LMF 152.

The GMLC 155 may support a location request for the UE 105 received from an external client 130 or from a Home GMLC (HGMLC) in a separate HPLMN, not shown, and may forward such a location request to the AMF 154 for forwarding by the AMF 154 to the LMF 152 or may forward the location request directly to the LMF 152. A location response from the LMF 152 (e.g. containing a location estimate for the UE 105) may be similarly returned to GMLC 155 either directly or via the AMF 154 and the GMLC 155 may then return the location response (e.g., containing the location estimate) to the external client 130 or to a HGMLC. The GMLC 155 is shown connected to both the AMF 154 and LMF 152, but only one of these connections may be supported by 5GCN 150 in some implementations.

A Location Retrieval Function (LRF) 157 may be connected to, or may be part of, the GMLC 155, as defined in 3GPP Technical Specifications (TS) 23.271 and 23.273. LRF 157 may perform the same or similar functions to GMLC 155, with respect to receiving and responding to a location request from an external client 130 that corresponds to a Public Safety Answering Point (PSAP) supporting an emergency call from UE 105.

The LMF 152 may communicate with the gNBs 110 and/or with the ng-eNB 114 using a New Radio Position Protocol A (NRPPa), defined in 3GPP Technical Specification (TS) 38.455, with NRPPa messages being transferred between a gNB 110 and the LMF 152, and/or between an ng-eNB 114 and the LMF 152 via the AMF 154. The LMF 152 and UE 105 may also communicate using the LTE Positioning Protocol (LPP) defined in 3GPP TS 36.355 and TS 37.355. Here, LPP and/or LPP/LPPe messages may be transferred between the UE 105 and the LMF 152 via the AMF 154 and a serving gNB 110-1 or serving ng-eNB 114 for UE 105. For example, LPP and/or LPP/LPPe messages may be transferred between the LMF 152 and the AMF 154 using a service based protocol based on the HyperText Transfer Protocol (HTTP), and may be transferred between the AMF 154 and the UE 105 using a 5G Non-Access Stratum (NAS) protocol. The LPP and/or LPP/LPPe protocol may be used by LMF 152 to support positioning of UE 105 using UE assisted and/or UE based DL and/or UL-DL position methods such as A-GNSS, RTK, DL-TDOA, DLAOD, multi-RTT, ECID and/or WLAN positioning. The NRPPa protocol may be used by LMF 152 to support positioning of UE 105 using UL and UL-DL position methods such as UL-TDOA, UL-AOA, multi-RTT and/or ECID, and/or may be used by LMF 152 to obtain location related information from gNBs 110 and/or ng-eNB 114, such as parameters defining PRS transmissions from gNBs 110 and/or ng-eNB 114. For example, location related information provided by the gNBs 110 and/or ng-eNB 114 to the LMF 152 using NRPPa may include timing and configuration information for PRS transmission from gNBs 110 and/or ng-eNB 114 and/or location coordinates of the gNBs 110 and/or ng-eNB 114. The LMF 152 can then provide some or all of this location related information to the UE 105 as assistance data in an LPP message via the NG-RAN 112 and the 5GCN 150 in order to support DL and/or UL-DL position methods by UE 105.

With a UE assisted DL or UL-DL position method, UE 105 may obtain DL location measurements and send the measurements to a location server (e.g. LMF 152) for computation of a location estimate for UE 105. For example, the DL location measurements may include one or more of a Received Signal Strength Indication (RSSI), RTT, UE Receive Time-Transmission Time Difference (Rx-Tx), Reference Signal Time Difference (RSTD), Reference Signal Received Power (RSRP), Reference Signal Received Quality (RSRQ), AOA, and/or AOD for gNBs 110, ng-eNB 114 and/or a WLAN access point (AP). The DL location measurements may also or instead include measurements of GNSS pseudorange, code phase and/or carrier phase for SVs 190.

With a UE based DL or UL-DL position method, UE 105 may obtain DL location measurements (e.g. which may be the same as or similar to location measurements for a UE assisted DL or UL-DL position method) and may compute a location of UE 105 (e.g. with the help of assistance data received from a location server such as LMF 152 or broadcast by gNBs 110, ng-eNB 114 or other base stations or APs). With an UL or UL-DL position method, one or more base stations (e.g. gNBs 110 and/or ng-eNB 114) or APs may obtain location measurements (e.g. measurements of gNB Rx-Tx, RSSI, RTT, RSRP, RSRQ, AOA or Time Of Arrival (TOA)) for signals transmitted by UE 105, and/or may receive measurements obtained by UE 105, and may send the measurements to either a location server (e.g. LMF 152) or the UE 105 for computation of a location estimate for UE 105.

Information provided by the gNBs 110 and/or ng-eNB 114 to the location server, e.g., LMF 152, using NRPPa, may include timing and configuration information for PRS transmission and location coordinates. The location server may then provide some or all of this information to the UE 105 as assistance data in an LPP and/or LPP/LPPe message via the NG-RAN 112 and the 5GCN 150.

An LPP or LPP/LPPe message sent from the LMF 152 to the UE 105 may instruct the UE 105 to do any of a variety of things, depending on desired functionality. For example, the LPP or LPP/LPPe message could contain an instruction for the UE 105 to obtain measurements for GNSS (or A-GNSS), WLAN, DL-TDOA, multi-RTT, DL-AOD, or some other position method. In the case of DLTDOA, the LPP or LPP/LPPe message may instruct the UE 105 to obtain one or more measurements (e.g. RSTD measurements) of PRS signals transmitted within particular cells supported by particular gNBs 110 (or supported by one or more ng-eNBs or eNBs). The UE 105 may send the measurements back to the LMF 152 in an LPP or LPP/LPPe message (e.g. inside a 5G NAS message) via the serving gNB 110-1 (or serving ng-eNB 114) and the AMF 154.

As illustrated, 5GCN 150 includes a Unified Data Management (UDM) 156 that may be connected to the GMLC 155 (e.g., via the Internet), as well as a User Plane Function (UPF) 157. The UDM 156 is analogous to a Home Subscriber Server (HSS) for LTE access, and if desired, the UDM 156 may be combined with an HSS. The UDM 156 is a central database that contains user-related and subscription related information for UE 105 and may perform the following functions: UE authentication, UE identification, access authorization, registration and mobility management, subscription management and SMS management.

The UPF 157 may support voice and data bearers for UE 105 and may enable UE 105 voice and data access to other networks such as the Internet. UPF functions may include: external PDU session point of interconnect to a Data Network, packet (e.g. Internet Protocol (IP)) routing and forwarding, packet inspection and user plane part of policy rule enforcement, Quality of Service (QOS) handling for user plane, downlink packet buffering and downlink data notification triggering.

The UPF 157 may be connected to a location server (LS), such as the SLP 159. The SLP 159 may support the SUPL user plane (UP) location solution defined by the Open Mobile Alliance (OMA) and may support location services for UE 105 based on subscription information for UE 105 stored in SLP 159. The SLP 159 may function as a home SLP (SLP) for UE 105, a Discovered SLP (D-SLP) and/or as an Emergency SLP (E-SLP). SLP 159 and LMF 152 in communication system 100 are both examples of a LS that may employ the LPP and/or LPP/LPPe protocols for positioning of UE 105.

To support a SUPL location session between UE 105 and SLP 159 in communication system 100, the UE 105 and SLP 159 may exchange SUPL messages at a user plane level using IP and TCP (or possibly UDP for an initial SUPL INIT message) as transport protocols. FIG. 1 shows a typical path 170 for a SUPL message, which comprises routing the SUPL message through gNB 110-1 and UPF 157, in this order, for a SUPL message sent from UE 105 to SLP 159, or in the reverse order for a SUPL message sent from SLP 159 to UE 105.

With a normal SUPL location solution, SLP 159 may not be connected to AMF 154. However, with an extended SUPL solution, SLP 159 may be connected to AMF 154. For example, SLP 159 may be connected to AMF 154 using the same or a similar service based protocol as used to connect AMF 154 to LMF 152, which may facilitate transfer of NRPPa messages between SLP 159 and gNBs 110 and/or ng-eNB 114 via AMF 154. Alternatively, SLP 159 may be connected to LMF 152 or physically combined with LMF 152 in order to transfer NRPPa messages between SLP 159 and gNBs 110 and/or ng-eNB 114 via AMF 154, and via LMF 152 when LMF 152 is connected to but not combined with LMF 152.

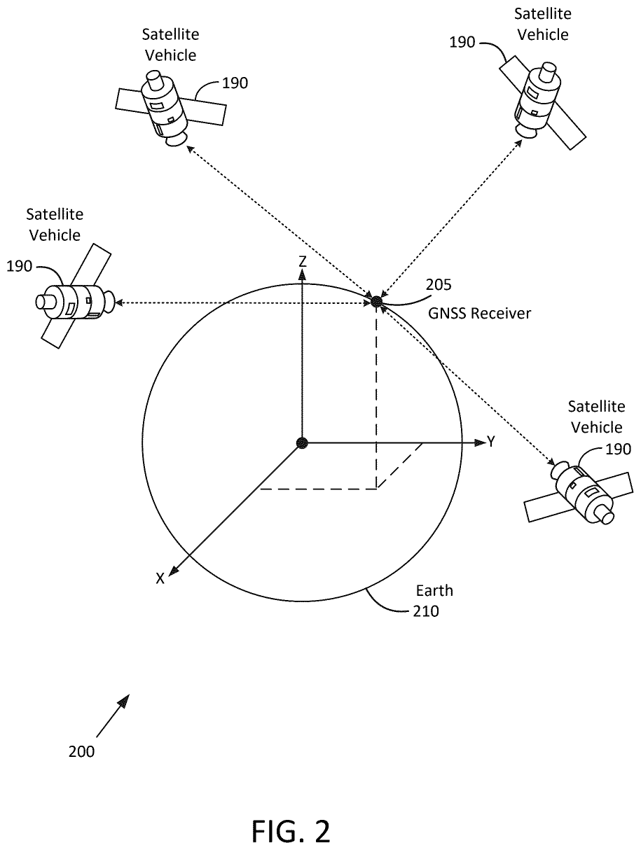

FIG. 2 is a simplified diagram of a GNSS system 200 that can be used to describe how GNSS signals may be used to determine timing information and/or to determine an accurate location of a GNSS receiver 205 on earth 210. Put generally, the GNSS system 200 enables an accurate GNSS position fix of the GNSS receiver 205, which is configured to receive RF signals from GNSS satellites 190 that can be a part of one or more GNSS constellations. The types of GNSS receiver 205 used may vary, depending on application. In some embodiments, for instance, the GNSS receiver 205 may comprise a standalone device or component incorporated into another device (e.g., a mobile device). Some examples of a standalone device may include a smartphone, an unmanned aerial vehicle (UAV), a laptop computer, and a navigation aid. In some embodiments, the GNSS receiver 205 may be integrated into industrial or commercial equipment, such as survey equipment, Internet of Things (IoT) devices, etc.

It will be understood that the diagram provided in FIG. 2 is greatly simplified. In practice, there may be dozens of satellites 190 and many GNSS constellations that can belong to various GNSS systems. Some examples of GNSS systems include GPS, Galileo, GLONASS, and BDS. Additional GNSS systems can include Quasi-Zenith Satellite System (QZSS) over Japan and Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is typically based on trilateration/multilateration, which is a method of determining position by measuring distances to points at known coordinates. In general, the determination of the position of a GNSS receiver 205 in three dimensions may rely on a determination of the distance between the GNSS receiver 205 and four or more satellites 190. As illustrated, 3D coordinates may be based on a coordinate system (e.g., XYZ coordinates; latitude, longitude, and altitude; etc.) centered at the earth's center of mass. A distance between each satellite 190 and the GNSS receiver 205 may be determined using precise measurements made by the GNSS receiver 205 of a difference in time from when a RF signal is transmitted from the respective satellite 190 to when it is received at the GNSS receiver 205. To help ensure accuracy, not only does the GNSS receiver 205 need to make an accurate determination of when the respective signal from each satellite 190 is received, but many additional factors need to be considered and accounted for. These factors include, for example, clock differences at the GNSS receiver 205 and satellite 190 (e.g., clock bias), a precise location of each satellite 190 at the time of transmission (e.g., as determined by the broadcast ephemeris), the impact of atmospheric distortion (e.g., ionospheric and tropospheric delays), and the like.

To perform a traditional GNSS position fix, the GNSS receiver 205 can use code-based positioning to determine its distance to each satellite 190 based on a determined delay in a generated pseudorandom binary sequence received in the RF signals received from each satellite, in consideration of the additional factors and error sources previously noted. With the distance and location information of the satellites 190, the GNSS receiver 205 can then determine a position fix for its location. This position fix may be determined, for example, by a Standalone Positioning Engine (SPE) executed by one or more processors of the GNSS receiver 205. However, code-based positioning is relatively inaccurate and, without error correction, is subject to errors. Even so, code-based GNSS positioning can provide a positioning accuracy for the GNSS receiver 205 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellites 190 observed by the GNSS receiver 205 can be mitigated or canceled based on similar carrier-based ranging of the satellites 190 using a highly accurate GNSS receiver at the base station at a known location. These measurements and the base station's location can be provided to the GNSS receiver 205 for error correction. This position fix may be determined, for example, by a Precise Positioning Engine (PPE) executed by one or more processors of the GNSS receiver 205. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters).

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions.

Referring again to FIG. 2, the satellites 190 may be members of a single satellite constellation, i.e., a group of satellites that are part of a GNSS system, e.g., controlled by a common entity such as a government, and orbiting in complementary orbits to facilitate determining positions of entities around the world. One or more of the satellites 190 may transmit multiple satellite signals in different GNSS frequency bands, such as L1, L2, and/or GAL E1 frequency bands. The terms GPS L1 band, GPS L2 band, and GAL E1 band are used herein because these terms pertain to GNSS signals having respective ranges of frequencies. Various receiver configurations may be used to receive satellite signals. For example, a receiver may use separate receive chains for different frequency bands. As another example, a receiver may use a common receive chain for multiple frequency bands that are close in frequency to each other. As another example, a receiver may use separate receive chains for different signals in the same band, for example GPS L1 and GLONASS L1 sub-bands. A single receiver may use a combination of two or more of these examples. These configurations are examples, and other configurations are possible. The use of multiple receivers is based on taking into consideration various factors and trade-offs such as, for example, hardware cost, software implementation and execution costs, and other costs associated with use of GNSS owned and operated by multiple entities. The example embodiments described herein address how to minimize, or eliminate, such costs, based on selecting and exclusively using one of the multiple GNSS. Further details pertaining to this aspect are provided below.

Multiple satellite bands are allocated to satellite usage. These bands include the L-band used for GNSS satellite communications, the C-band used for communications satellites such as television broadcast satellites, and the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

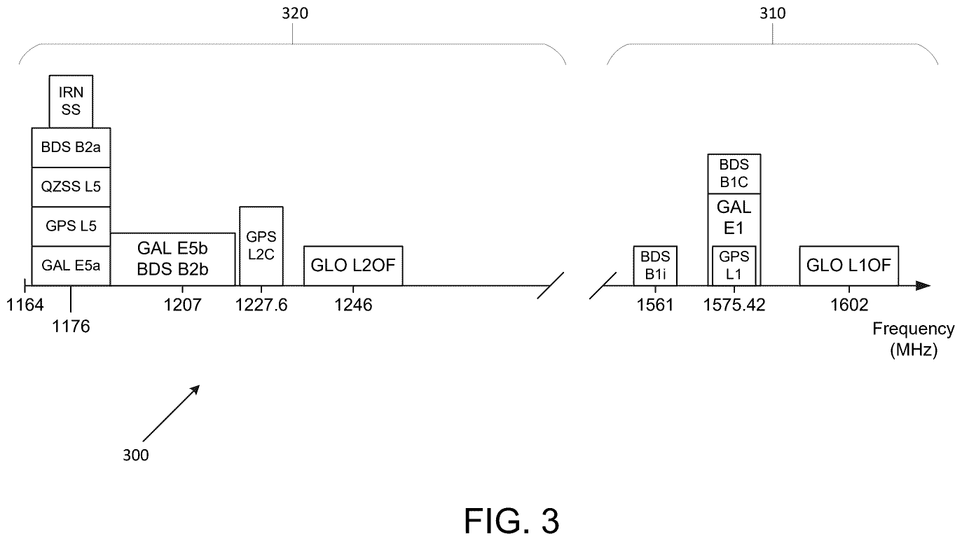

FIG. 3 is a diagram of GNSS frequency bands 300, which may be used in GNSS receivers. (Like other figures, FIG. 3 is not shown to scale). The GNSS frequency bands 300 show that GNSS constellations operate on several frequencies in the L-Band. The L1 frequency band typically covers frequencies from 1559 MHz to 1606 MHz and includes L1 signals from GPS, Galileo, BDS, GLONASS, and QZSS GNSS constellations. Bands within this spectrum may be referred to herein as the “upper bands” 310. The same constellations that use these upper bands 310 may also transmit concurrently using one or more other bands in the frequency spectrum generally from 1164 MHz to 1246 MHz, which may be referred to herein as the “lower bands” 320. Example bands within the lower bands 320 include the L2 frequency band and the L5 frequency band. Satellites may transmit, for example L2 and/or L5 signals along with L1 signals. L2 and L5 signals may complement the L1 signals, which have been used for many years. For example, the L5 signals have wider signal bandwidth than the L1 signals, which helps improve positioning performance in multi-path environments. Also, using the L5 signals in addition to the L1 signals can allow for frequency diversity. The L2 and L5 signals are far enough away in frequency from the L1 signals, for example, that different processing paths are typically used to measure the L2 and L5 signals versus the L1 signals.

The GPS L1 band includes a GPS LICA signal, which may be also referred to as “GPS L1 C/A” or “C/A band at L1.” The GPS LICA signal is generally recognized as a legacy signal and is widely used in various civilian applications. A coarse/acquisition (C/A) code associated with the GPS LICA band is a pseudo-random noise (PRN) code that is based on the Gold code and has a 1 millisecond length at a chipping rate of 1.023 Mbps.

The C/A code is typically used for acquisition of a P/Y code in a GNSS signal. The GNSS P Code signal is a precision signal that is coded by a precision code. The Y code is used in place of the P code whenever an Anti-Spoofing (A/S) mode of operation is activated. The PRN associated with the P code for satellite vehicle (SV) number “i” is a ranging code Pi(t) that is 7 days long at a chipping rate of 10.23 Mbps.

An M code that is currently used exclusively in military applications may eventually replace the P/Y code. The M-Code provides better jamming resistance than the P/Y signal, primarily through enabling transmission at much higher power without interference with C/A code or P/Y code receivers.

The GPS L1 code is further classified as either a LIC code (for civilian use) or a LIM code (for military use). The GPS LIC code, which is a relatively new code in comparison to the LICA code, has been designed for interoperability with GAL E1. The L1C code is compatible with conventional L1 signals used in current practice, but is broadcast at a higher power level and includes advanced design features that offer enhanced performance.

The GPS L2C signal is directed at features such as improving accuracy of navigation, providing an easy-to-track signal, and acting as a redundant signal in case of localized interference. Unlike the GPS C/A code, GPS L2C contains two distinct PRN code sequences to provide ranging information—the civil-moderate code (known as CM code) and the civil-long length code (known as CL code). The CM code of the GPS L2CM band is 10,230 chips long and repeats every 20 ms. The CL code of the GPS L2CL is 767,250 chips long and repeats every 1500 ms. Each signal is transmitted at 511,500 chips per second (chip/s) and can be multiplexed together to form a 1,023,000-chip/s signal.

The GAL E1 signal has a 4092 code length with a 1.023 MHz chipping rate giving it a repetition rate of 4 ms. The GAL E1 signal has a center frequency that coincides with the center frequency of the GPS LICA band (1575.42 MHZ).

A GNSS receiver such as, for example, the GNSS receiver 205 described above, may be configured to perform location determination operations based on one or more of the various GNSS signals described above. However, the various operating frequencies and codes described above necessitate the use of specific hardware and software for use of the various GNSS signals. In various use-case scenarios, it may be cost-ineffective and/or impractical to use multiple GNSS systems for location determination. For example, it may be impractical to include hardware and software associated with a GNSS system that is unavailable in a country where the GNSS receiver is located, or is unusable in the country (due to restrictions imposed by various authorities, for example). Further details pertaining to this aspect are described below.

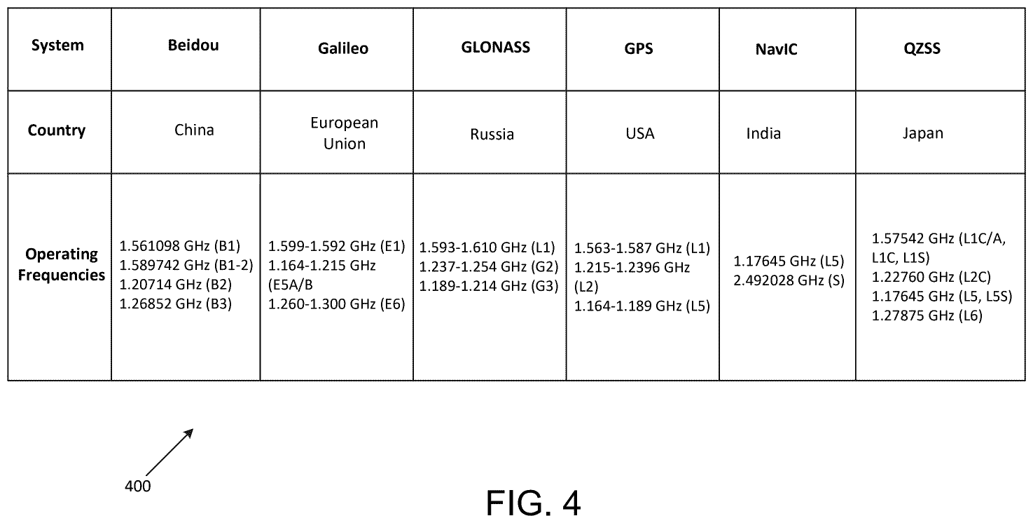

FIG. 4 shows a table 400 that lists various GNSS systems operating in various countries. The operating frequencies of the various GNSS systems is also included in the table 400. In an example scenario, a GNSS receiver located in the United States may be configured to perform location determination operations based on use of one or more frequency bands of GPS. However, such a GNSS receiver may be constrained from using of some other GNSS systems for one or more reasons. For example, the GNSS receiver may be constrained from using Beidou due to regulatory restrictions. T

Furthermore, the GNSS receiver located in the United States may be unable to receive GNSS signals from regional GNSS systems such as Quasi-Zenith Satellite System (QZSS) over Japan and Indian Regional Navigational Satellite System (IRNSS) over India. The Quasi-Zenith Satellite System (QZSS), which is also known as Michibiki, is a four-satellite regional satellite navigation system developed by the Japanese government to enhance GPS-based location determination operations in some regions of Asia, with a focus on Japan. The Indian Regional Navigation Satellite System (IRNSS), which is also known as NavIC, is another regional satellite navigation system that provides accurate real-time positioning and timing services covering India.

It may therefore be advantageous to configure the GNSS located in the United States to exclusively use GPS for performing location determination operations and either omit, or eliminate, location determination operations that use other GNSS systems.

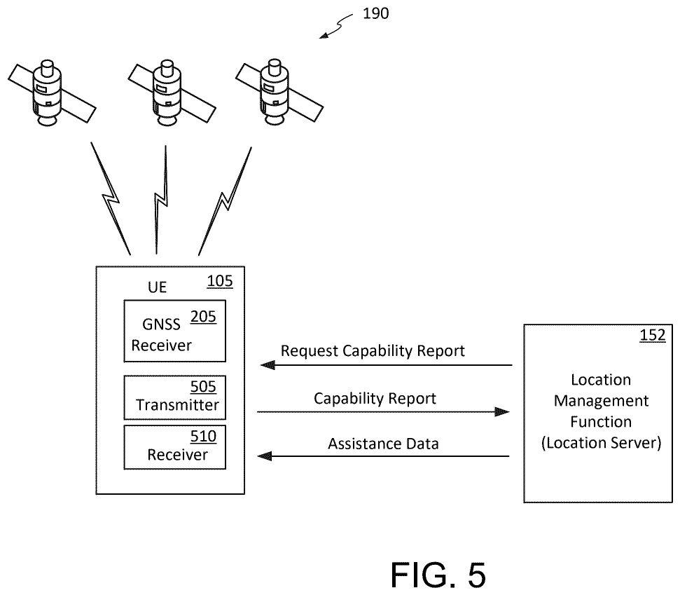

FIG. 5 shows an example scenario where a UE communicates with a location server to perform positioning operations. In this example scenario, the UE is the UE 105 described above and the location server is the Location Management Function (LMF) 152 described above with reference to FIG. 1. Further details pertaining to the illustrated scenario are described below following a general description pertaining to location/positioning operations.

To support positioning of a mobile device, two broad classes of location solutions have been defined: control plane and user plane. With control plane (CP) location, signaling related to positioning and support of positioning may be carried over existing network (and mobile device) signaling interfaces and using existing protocols dedicated to the transfer of signaling. With user plane (UP) location, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane location solutions for mobile devices that use radio access according to Global System for Mobile communications GSM (2G), Universal Mobile Telecommunications System (UMTS) (3G), Fourth Generation (4G) Long Term Evolution (LTE), and Fifth Generation (5G) New Radio (NR) and Wireless Local Area Network (WLAN).

These solutions are defined in 3GPP Technical Specifications (TSs) 23.271 (common part for 2G-4G), 43.059 (GSM access), 25.305 (UMTS access), 36.305 (LTE access), and 23.273 and 38.305 (5G access). The Open Mobile Alliance (OMA) has similarly defined a user plane location solution known as Secure User Plane Location (SUPL) which can be used to locate a mobile device accessing any of a number of radio interfaces that support IP packet access such as General Packet Radio Service (GPRS) with GSM, GPRS with UMTS, or IP access with LTE, NR or WLAN.

Both CP and UP location solutions may employ a location server (LS) to perform positioning. The LS may be part of, or accessible from, a serving network or a network for a user equipment (UE) or may simply be accessible over the Internet or over a local Intranet. If positioning of a UE is needed, an LS or a UE may initiate a session (e.g. a location session or a SUPL session) between the UE and the LS and coordinate location measurements by the UE and/or by a network and determination of an estimated location of the UE. During a location session, an LS may request positioning capabilities of the UE (or the UE may provide them without a request), may provide assistance data to the UE (e.g. if requested by the UE or in the absence of a request) and may request a location estimate or location measurements from the UE, e.g., for position methods such as Assisted Global Navigation Satellite System (A-GNSS), Uplink (UL) Time Difference of Arrival (TDOA), Downlink (DL) TDOA, multi-cell Round Trip signal propagation Time (RTT) also referred as multiRTT, UL angle of arrival (UL-AOA), DL angle of departure (DL-AOD), and/or Enhanced Cell ID (ECID). It is noted that Round Trip signal propagation Time (RTT) may also be referred to more simply as “Round Trip Time” which may also be abbreviated as RTT. This aspect, where the LS requests positioning capabilities of the UE, is illustrated in FIG. 5 in the form of a communication labeled as “Request Capability Report” from the LMF 152 to the UE 105. The request capability report can be received by a receiver 510 that is a part of the UE 105. The UE 105 may respond to the request from the LMF 152 by transmitting a capability report. The capability report can include, in accordance with the disclosure, an indication of preference for use by the UE, a specific GNSS system such as, for example, a preference for use of a GPS system (when the UE 105 is located in the US). The capability report can be transmitted by the UE 105 by use of a transmitter 505 of the UE 105. In some operating scenarios, the UE 105 may transmit the capability report to the LMF 152 without receiving a request capability report. In some operating scenarios, the UE 105 may generally broadcast the capability report without receiving a request capability report from any LMF or other requesting device. Additional details pertaining to the capability report are provided below.

In the illustrated example, the LMF 152 receives the capability report provided by the UE 105 and transmits assistance data (AD) to the UE 105. The assistance data may be used by the UE 105 to help acquire and measure signals from the preferred GNSS system (in this example, GPS system). More particularly, the assistance data can include information related to expected characteristics of the GNSS signals such as, for example, frequency, bandwidth, expected time of arrival, beam angles, signal coding, and signal Doppler.

In a UE based mode of operation (also referred to as UE based positioning), assistance data may also, or instead, be used by the UE 105 to help determine a location estimate for the UE 105 from location measurements obtained by the UE 105 (e.g., if the assistance data provides satellite ephemeris data in the case of A-GNSS positioning or base station locations and other base station characteristics such as PRS timing in the case of terrestrial positioning using DL-TDOA or multi-RTT).

In an alternative UE assisted mode of operation (also referred to as UE assisted positioning), the UE 105 may return location measurements to the LMF 152 which may determine an estimated location of the UE 105 based on these measurements and possibly based also on other known or configured data (e.g. satellite ephemeris data for a GNSS location or base station characteristics including base station locations and possibly PRS timing in the case of terrestrial positioning using DL-TDOA or multiRTT).

In another standalone mode of operation, the UE 105 may make location related measurements without any positioning assistance data from the LMF 152 and may further compute a location or a change in location without any positioning assistance data from the LMF 152. Position methods that may be used in a standalone mode include GPS and GNSS (e.g. if a UE obtains satellite orbital data from navigation data broadcast by GPS or GNSS satellites themselves) as well as sensors. It is noted that the terms “positioning assistance data”, “location assistance data” and “assistance data” (AD) are used synonymously herein to refer to data which may be provided to a mobile device via broadcast (e.g. by a base station) or by point to point means (e.g. by the LMF 152) to assist the mobile device to obtain location measurements (also referred to as positioning measurements) and/or to compute a location estimate from positioning measurements.

In the case of 3GPP CP location, a location server may be an enhanced serving mobile location center (E-SMLC) in the case of LTE access, a standalone SMLC (SAS) in the case of UMTS access, a serving mobile location center (SMLC) in the case of GSM access, or the LMF 152 in the case of 5G (e.g. NR or WLAN) access. In the case of OMA SUPL location, the LMF 152 may be a SUPL Location Platform (SLP) which may act as any of: (i) a home SLP (H-SLP) if in or associated with the home network of the UE 105 or if providing a permanent subscription to the UE 105 for location services; (ii) a discovered SLP (D-SLP) if in or associated with a serving or non-home network or if not associated with any network; (iii) an Emergency SLP (E-SLP) if supporting location for an emergency call initiated by the UE; or (iv) a visited SLP (V-SLP) if in or associated with a serving network or a current local area for the UE 105.

During a location session (also referred to as a positioning session), the UE 105 and the LMF 152 may exchange messages (such as the request capability report, the capability report, and the assistance data) defined according to some positioning protocol. The messages are exchanged in specific sequence in order to coordinate various stages necessary for the determination of an estimated location for the UE 105. Possible positioning protocols may include, for example, the LTE Positioning Protocol (LPP) defined by 3GPP in 3GPP TS 36.355 and TS 37.355 and the LPP Extensions (LPPe) protocol defined by OMA in OMA TSs OMA-TS-LPPe-V1_0, OMA-TS-LPPe-V1_1 and OMA-TS-LPPe-V2_0. The LPP and LPPe protocols may be used in combination where an LPP message contains an embedded LPPe message. The combined LPP and LPPe protocols may be referred to as LPP/LPPe. LPP and LPP/LPPe may be used to help support the 3GPP control plane location solution for LTE, NR and WLAN access, in which case LPP or LPP/LPPe messages are exchanged between a UE and E-SMLC or LMF.

LPP or LPP/LPPe messages may be exchanged between the UE 105 and E-SMLC via a serving Mobility Management Entity (MME) and a serving evolved NodeB (eNB) for the UE 105 in the case of LTE access. LPP or LPP/LPPe messages may also be exchanged between the UE 105 and the LMF 152 via a serving Access and Mobility management Function (AMF) and a serving NR NodeB (referred to as a gNB) for the UE 105 in the case of NR or WLAN 5G access.

LPP and LPP/LPPe may also be used to help support the OMA SUPL solution for many types of wireless access that support IP messaging (such as LTE, NR and WLAN), where LPP or LPP/LPPe messages are exchanged between a SUPL Enabled Terminal (SET), which is the term used for a UE with SUPL, and an SLP, and may be transported within SUPL messages, such as a SUPL POS or SUPL POS INIT message, which may be conveyed using TCP and IP protocols.

The LMF 152 and a base station (e.g. an eNB for LTE access or gNB for NR access) may exchange messages to enable the LMF 152 to (i) obtain position measurements for a particular UE from the base station, or (ii) obtain location information from the base station not related to a particular UE such as the location coordinates of an antenna for the base station, the cells (e.g. cell identities) supported by the base station, cell timing for the base station and/or parameters for signals transmitted by the base station such as PRS signals. In the case of LTE access, the LPP A (LPPa) protocol defined in 3GPP TS 36.455 may be used to transfer such messages between a base station that is an eNB and a LS that is an E-SMLC. In the case of NR access, the NR Positioning Protocol A (NRPPa) defined in 3GPP TS 38.455 may be used to transfer such messages between a base station that is either a gNB providing NR access or an eNB (referred to as a next generation eNB or ng-eNB) providing 5G LTE access and a LS that is an LMF.

Position methods (also referred to as positioning methods or as posmethods) may be classified as downlink (DL), uplink (UL) or uplink-downlink (UL-DL). With a downlink position method, a UE which is being positioned obtains DL location measurements of DL signals transmitted from space vehicles (SVs), base stations (e.g. gNBs and/or ng-eNBs), access points (APs) (e.g. WiFi APs) and/or positioning only beacons. The UE then either determines a location estimate from these measurements in the case of UE based positioning, or sends the measurements to a location server to determine a location in the case of UE assisted positioning. Examples of DL position methods include DL-TDOA, DL-AOD and ECID.

With an uplink position method, a UE which is being positioned transmits UL signals, which may carry control information and/or data, to one or more base stations (e.g. gNBs and/or ng-eNBs), access points (e.g. WiFi APs) and/or reception points in or associated with a serving network for the UE, and which obtain UL location measurements of the transmitted UL signals. Examples of UL signals carrying control information only include UL PRS and UL Sounding Reference Signals (SRS). The one or more base stations, access points and/or reception points then pass the UL location measurements to a positioning entity, such as an LS, which determines a location estimate for the UE from these measurements. Examples of UL position methods include UL-TDOA, UL-AOA, and ECID (in a variant in which network side measurements are used).

With an uplink-downlink (UL-DL) position method, DL location measurements are obtained by the UE as for a DL position method and UL location measurements are obtained by one or more base stations, access points or reception points as for an UL position method. Then, in the case of UE based positioning, the UL measurements are transferred to the UE to obtain a location estimate.

Alternatively, in the case of UE assisted positioning, the DL measurements and UL measurements are both transferred to an LS to obtain a location estimate. An example of an UL-DL position method is multi-RTT.

CP location solutions such as the CP location solutions defined by 3GPP can support all three types of position method (UL, DL and UL-DL) because the use of existing signaling interfaces and signaling protocols, that are used to request and obtain location measurements and request and receive other location related information, enable an LS to interact with all potential participating entities.

FIG. 6 shows a flow diagram 600 of a method performed by a user equipment for generating and transmitting a capability report to a location server. Means for performing the functionality illustrated in one or more of the blocks shown in FIG. 6 may be performed by hardware and/or software components of a UE (such as the UE 105) and a location server (such as the LMF 152). The description below refers to the UE 105 and the LMF 152, but it must be understood that the description is applicable to any of various UEs and location servers in accordance with the disclosure.

At block 605, the functionality can include the UE 105 identifying a first country in which the UE 105 is camped. In a first example scenario, the UE 105 may make an identification that the UE 105 is camped at a location in the US. In a second example scenario, the UE 105 may make an identification that the UE 105 is camped at a location in India. The identification can be carried out in various ways. In an example implementation, the UE 105 is a mobile device, such as, for example, a mobile phone and a processor in the mobile phone may make a determination that the mobile phone is located in the US. The processor may make the determination, for example, by evaluating a public land mobile network (PLMN) code stored in a subscriber identity module (SIM) card in the mobile phone. The PLMN is a globally unique code that includes a country code and a network code. The PLMN code in the example case of the mobile phone would indicate that the country is USA and the network code is a mobile network code of a network services provider.

In the two example scenarios indicated above, the country code associated with the US is distinctly different from the country code associated with India. The PLMN code can further include information such as an International Mobile Subscriber Identity (IMSI) code and/or an International Mobile Equipment Identity (IMEI). In another implementation, the processor in the mobile phone may obtain a mobile country code (MCC) from any of various sources such as, for example, from another device (LS 152, for example) or from information stored in a memory in the mobile phone.

At block 610, the functionality can include the UE 105 identifying a GNSS that is preferred for use by the UE 105 in the country in which the UE 105 is camped. The identification may be carried out, for example, based on evaluating a compatibility for use by the UE 105 of one or more GNSS systems that are usable/available/unavailable in the country in which the UE 105 is camped. In an example scenario, a first GNSS that is evaluated by the UE 105 can operate in an upper band of L1 GNSS frequencies and a second GNSS that is evaluated by the UE 105 can operate in a lower band of L1 GNSS frequencies.

In the first example scenario indicated above where the UE 105 (the mobile phone, for example) is camped in the US, the preferred GNSS can be GPS, based on one or more factors such as, for example, a lack of availability and/or usability of one or more other GNSS systems in the US. In the second example scenario indicated above where the UE 105 (the mobile phone, for example) is camped in India, the preferred GNSS can be, for example, NavIC, based on one or more factors such as, for example, a preference for use of a regional GNSS system.

In an example embodiment, a single GNSS may be selected as the preferred GNSS to the exclusion of one or more other GNSS systems. In another example embodiment, two or more GNSS systems may be selected and an order of preference may be determined. For example, in the second example scenario indicated above where the UE 105 (the mobile phone, for example) is camped in India, a first preferred GNSS can be, for example, NavIC, and a second preferred GNSS can be, for example, GPS, based on one or more factors such as, for example, having a fallback option to perform position operations when the UE 105 is unable to receive a signal from the NavIC system (due to weather conditions or an operating environment, for example).

At block 615, the functionality can include the UE 105 generating a capability report. The capability report may include an indication of preference by the UE 105 for use of the GNSS identified at block 610. Thus, in the first example scenario indicated above where the UE 105 is camped in the US, the capability report generated by the UE 105 can provide an indication that GPS is the preferred GNSS for use by the UE 105. Further, in the second example scenario indicated above where the UE 105 is camped in India, the capability report generated by the UE 105 can provide an indication that NavIC system is the first preferred GNSS for use by the UE 105 and GPS is the second preferred GNSS for use by the UE 105. In one embodiment, a “primary” preference (NavIC, in this example) and one or more “secondary” preferences (GPS, etc.) may be included in the capability report, for example, in the form of a list of preferences. The items in the list of preferences can be labeled in various ways such as, for example, “first GNSS preference,” “second GNSS preference,” etc.

Alternatively, in the second example scenario indicated above where the UE 105 is camped in India, a first capability report generated by the UE 105 at a first instant in time can provide an indication that NavIC system is the preferred GNSS for use by the UE 105. A second capability report generated by the UE 105 at another instant in time can provide an indication that GPS is the preferred GNSS for use by the UE 105. The second capability report may be generated, for example, when the UE 105 detects a lack of availability of signals from the NavIC system.

At block 620, the functionality can include transmitting the capability report to the location server. In an embodiment, the capability report is transmitted in one or more messages that are a part of a control plane call flow according to a long term evolution positioning protocol (LPP). As described above, the information contained in the capability report includes an indication of one or more GNSS systems preferred by the UE 105 for use in location determination operations. The capability report may also include an indication of items such as, for example, a mobile country code (MCC) associated with the country in which the UE 105 is camped, a mobile network code (MNC) associated with the country in which the UE 105 is camped, and/or a PLMN code associated with the UE 105. Such information that can be included in a capability report generated and transmitted by the UE 105 in accordance with the disclosure is typically not included in traditional practice, thereby providing various benefits, some of which are described below.

More particularly, control plane call flows in traditional practice, such as, for example, in accordance with the LTE Positioning Protocol (LPP) defined in 3GPP TS 36.355 and TS 37.355, do not include information pertaining to MCC, MNC, GNSS preference, etc. in the manner disclosed herein, because as indicated above, such protocols are dedicated to the transfer of signaling information. With user plane (UP) location, signaling related to positioning and support of positioning may be carried as part of data, using other protocols such as IP, TCP, UDP, and TCP/IP. However, traditional user plane based call flows, such as by use of the Secure User Plane Location (SUPL), also do not include information pertaining to a GNSS preference that is indicated by a UE to a location server and used by the location server, in the manner disclosed herein.

A first benefit that can be derived by use of the method described above with reference to FIG. 6 (and other figures) can pertain to UE operations. A UE that is configured to use a preferred GNSS and to eliminate use of at least one another GNSS, may provide various cost benefits and advantages in terms of operations. Cost benefits may be provided in the form of eliminating unnecessary/unused hardware and software. For example, in the case of the UE 105 located in the US, hardware/software related to use of GNSS systems other than a preferred GNSS system (GPS, for example), such as Beidou, NavIC and QZSS can be eliminated, thereby providing cost benefits. In another case, the UE 105 located in the US may include hardware/software related to use of the L1 GPS band as well as the L5 GPS band. However, costs associated with licensing fees, for example, may render the use of the L5 GPS band unattractive in terms of cost. Identifying and using the L1 GPS band as a preferred GNSS system eliminates the need for the UE 105 to perform operations associated with L5 GPS signals for location determination and further eliminates the need for the LMF 152 to provide the UE 105 with assistance data associated with L5 GPS.

Eliminating the need for the LMF 152 to provide the UE 105 with such unnecessary content in the assistance data allows the LMF 152 to generate assistance data in the form of curated assistance data or customized assistance data. Curated assistance data can include a GNSS support list that includes the preferred GNSS and omits other GNSS systems.

In an example embodiment, the LMF 152 can be configured to store (in a database, for example) information about multiple UEs, multiple countries, multiple GNSS preferences, availability information of one or more GNSS systems, and/or operating information associated with one or more GNSS systems. Such information may be obtained by use of crowdsourcing procedures. Crowdsourced information may be made available to any UE seeking information pertaining to one or more GNSS systems, such as, for example, to identify one or more GNSS systems that are available for use at a specific country/location, and/or to identify one or more codes (MCC, MNC, etc.). The provided information may be used by the UE to generate a capability report in accordance with the disclosure.

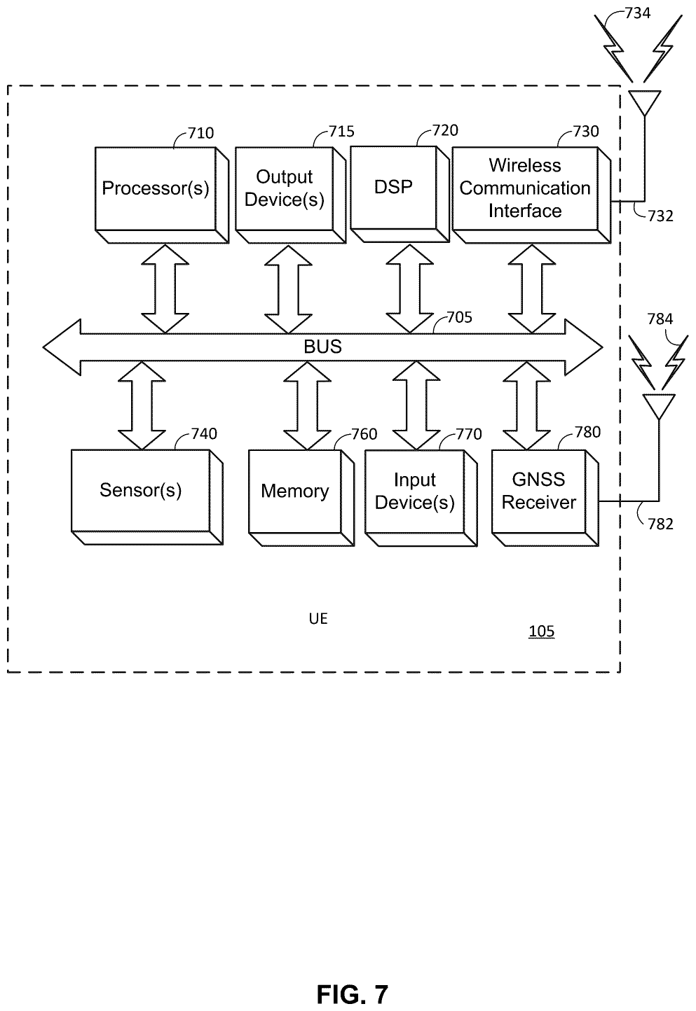

FIG. 7 illustrates some example functional components of an example UE 105 that can include a GNSS receiver 780 in accordance with the disclosure. The GNSS receiver 780 can include various hardware and software components for performing various operations in accordance with the disclosure. These operations can include, for example, the functions shown in the flow diagram illustrated in FIG. 6 and various other functions associated with the UE 105 depending on the nature of the UE 105. The memory 760 can store computer-executable instructions that can be executed by the processor(s) 710 for performing the various functions shown in the flow diagram illustrated in FIG. 6.

It should be noted that FIG. 7 is meant only to provide a generalized illustration of various components, any, or all of which may be utilized as appropriate. The UE 105 may vary in form and function, and may ultimately comprise any GNSS-enabled device, including phones, vehicles, commercial devices, consumer electronic devices, survey equipment, and more. Thus, in some instances, the UE 105 can be provided in the form of a single physical device and/or distributed among various networked devices, which may be disposed at different physical locations (e.g., different locations of a vehicle).

The UE 105 is shown as including hardware elements that can be electrically coupled via a bus 705 (or may otherwise be in communication, as appropriate). The hardware elements may include the processor(s) 710 which can include without limitation one or more general-purpose processors, one or more special-purpose processors (such as DSP chips, graphics processors (GPUs), application specific integrated circuits (ASICs), and/or the like), and/or other processor, processing structure, processing unit, or processing means. As shown in FIG. 7, some embodiments may have a separate DSP 720, depending on desired functionality. Location determination and/or other determinations may be executed by the processor(s) 710 based on wireless communication with other devices via a wireless communication interface 730 (discussed below). The UE 105 also can include one or more input devices 770, which can include without limitation a keyboard, touch screen, a touch pad, microphone, button(s), dial(s), switch(es), and/or the like; and one or more output devices 715, which can include without limitation a display, light emitting diode (LED), speakers, and/or the like. As will be appreciated, the type of input devices 770 and output devices 715 may depend on the type of UE 105 with which the input devices 770 and output devices 715 are integrated.

The UE 105 may also include the wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the UE 105 to communicate via networks and/or directly with other devices. The wireless communication interface 730 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 732 that send and/or receive wireless signals 734. The wireless communication antenna(s) 732 may be provided in the form of one or more discrete antennas, one or more antenna arrays, or any combination.

Depending on desired functionality, the wireless communication interface 730 may be provided in the form of separate transceivers, a separate receiver and transmitter, or any combination of transceivers, transmitters, and/or receivers to communicate with base stations and other terrestrial transceivers, such as wireless devices and access points. The UE 105 may communicate via the wireless communication interface 730 with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network, and a wireless personal area network (WPAN) may be a Bluetooth® network, an IEEE 802.15x, or some other type of network.

The UE 105 can further include sensor(s) 740. Sensor(s) 740 may comprise, without limitation, one or more inertial sensors (IMUs) and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the location determination described herein, in some instances.

The GNSS receiver 780 can receive signals 784 from one or more GNSS satellites via an antenna 782. The GNSS receiver 780 can extract a position of the GNSS receiver using position determination techniques, based on signals received from one or more GNSS satellite vehicles (SVs). The SVs can be a part of any one or more of GNSS systems, such as GPS, GAL, Global Navigation Satellite System (GLONASS), Quasi-Zenith Satellite System (QZSS) over Japan, Indian Regional Navigational Satellite System (IRNSS) over India, Beidou Navigation Satellite System (BDS) over China, and/or the like. Moreover, the GNSS receiver 780 can be used with various augmentation systems (e.g., Satellite-based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although the GNSS receiver 780 illustrated in FIG. 7 is illustrated as a component distinct from other components within the UE 105, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine (e.g., a PPE and/or SPE, which may be implemented using one or more of a KF, Weighted Least Squares (WLS), particle filter, etc.). In an example implementation, the position engine can use a PPP engine to determine a PPE solution and/or to generate RTK correction information using PPP correction information. The position engine may also be executed by one or more processors, such as processor(s) 710 and/or DSP 720.

The GNSS receiver 780 may further include and/or be in communication with a memory 760. The memory 760 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the processor(s) 710 and/or DSP 720 within the UE 105. In an aspect, then, such code and/or instructions can be used to configure and/or adapt a general-purpose computer (or other device) to perform one or more operations in accordance with the described methods.

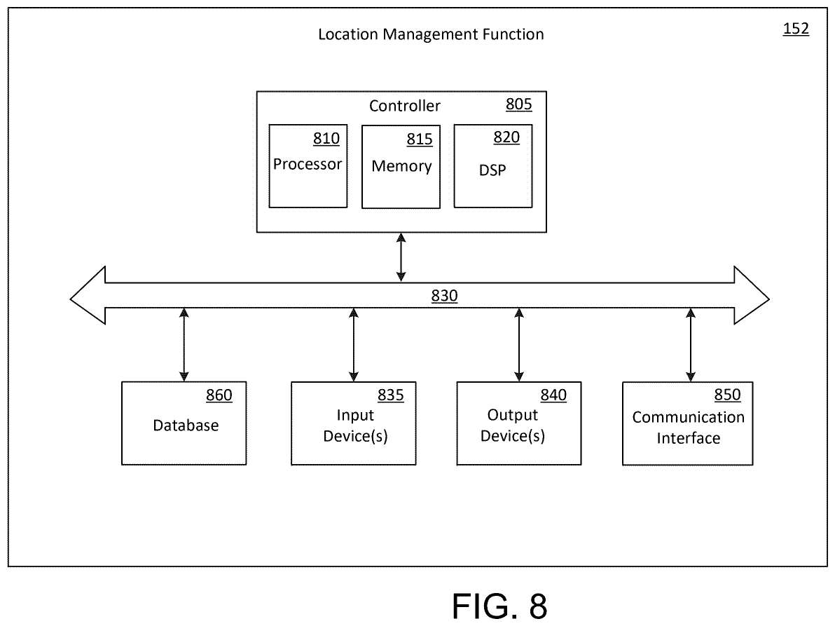

FIG. 8 shows a block diagram of various hardware components of a location server such as the LMF 152, according to an embodiment. It should be noted that FIG. 8 is meant only to provide a generalized illustration of various components, any or all of which may be utilized as appropriate. The LMF 152 may vary in form and function, and may ultimately comprise any device that can perform the functions described herein in accordance with disclosure.

It must be understood that the LMF 152 is shown as including various hardware components some of which may support operations associated with generating and providing assistance data as described above and some of which may support primary functions of the LMF 152 (such as, for example, server-related functions).

In this example, the various hardware components can be electrically coupled via a bus 830 (or may otherwise be in communication, as appropriate) and may include one or more processors, such as, for example, one or more general-purpose processors, one or more special-purpose processors (such as DSP chips, graphics processors (GPUs), application specific integrated circuits (ASICs), and/or the like), and/or other processor, processing structure, processing unit, or processing means. An example processor 810 is shown in FIG. 8. Some embodiments may have a separate DSP 820, depending on desired functionality. Various operations in accordance with the disclosure may be performed by the processor 810 in cooperation with various other components coupled to the bus 830. The hardware components may also include one or more memories, such as, for example, the memory 815. The processor 810 can communicate with the memory 815 and access software and/or firmware code stored in the memory 815 for executing various operations in accordance with the disclosure. In the illustrated example implementation, the processor 810, the memory 815, and the DSP 820 are components included in a controller 805. The controller 805 can include several other components that are not shown.

The LMF 152 may further include a communication interface 850 that is configured to allow the LMF 152 to communicate with elements such as, for example, an AMF 154 (shown in FIG. 1) and/or one or more other devices shown in FIG. 1.

The LMF 152 may further include a database 860 which may be used to store information such as, for example, information pertaining to one or more UEs and crowdsourced information described above. In an example implementation, the database 860 can be a part of the memory 815.

The LMF 152 can further include one or more input devices 835, which can include without limitation a keyboard, touch screen, a touch pad, microphone, button(s), dial(s), switch(es), and/or the like; and one or more output devices 840, which can include without limitation a display, light emitting diode (LED), speakers, and/or the like. As will be appreciated, the type of input devices 835 and output devices 840 may depend on the type of LMF 152 with which the input devices 835 and output devices 840 are integrated.

The methodologies described herein may be implemented by various means depending upon the application. For example, these methodologies may be implemented in hardware, firmware, software, or any combination thereof. For a hardware implementation, the one or more processors may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of UE 105 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a memory and executed by one or more processors, causing the one or more processors to operate as a special purpose computer programmed to perform the techniques disclosed herein. Memory may be implemented within the one or processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by UE 105 may be stored as one or more instructions or code on a non-transitory computer-readable storage medium such as memory 760. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for UE 105 may be provided as signals on transmission media included in a communication apparatus. For example, a communication apparatus comprising part or all of UE 105 may include a transceiver having signals indicative of instructions and data. The instructions and data are stored on non-transitory computer readable media, e.g., memory 760, and are configured to cause the one or more processors 710 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

In view of this description embodiments may include different combinations of features. Implementation examples are described in the following numbered clauses:

Clause 1: A method performed by a user equipment for generating and transmitting a capability report to a location server, the method comprising: identifying a first country in which the user equipment is camped; identifying, based at least in part on the identified first country, a first GNSS that is preferred for use by the user equipment; generating the capability report, the capability report including an indication of preference by the user equipment for use of the first GNSS; and transmitting the capability report to the location server in a control plane call flow according to a long term evolution positioning protocol (LPP).

Clause 2: The method of claim 1, wherein the capability report further includes a mobile country code associated with the first country in which the user equipment is camped.

Clause 3: The method of claim 1, wherein the user equipment is a mobile phone, and wherein the capability report further includes at least one of or a mobile network code or a public land mobile network (PLMN) code associated with the mobile phone.

Clause 4: The method of claim 3, wherein the PLMN code is stored in a subscriber identity module (SIM) card in the mobile phone.

Clause 5: The method of any one of claims 1-3, further comprising: configuring the user equipment to use the first GNSS and to eliminate use of at least one another GNSS.

Clause 6: The method of claim 5, wherein eliminating use of the at least one another GNSS comprises disabling one or more location determination operations that use the at least one another GNSS.

Clause 7: The method of claim any one of claims 1-6, wherein the indication of preference included in the capability report is based on evaluating a compatibility for use by the mobile phone of at least one another GNSS that is available for use in the first country.

Clause 8: The method of claim 7, wherein the first GNSS operates in an upper band of L1 GNSS frequencies and the at least one another GNSS operates in a lower band of L1 GNSS frequencies.

Clause 9: The method of claim 7, wherein evaluating the compatibility for use by the mobile phone of the at least one another GNSS is based at least in part on evaluating a capability of the mobile phone to operate upon GNSS signals provided by the at least one another GNSS.

Clause 10: A user equipment configured to generate and transmit a capability report to a location server, the user equipment comprising: one or more transmitters; one or more memories; and one or more processors communicatively coupled with the one or more transmitters and the one or more memories, wherein the one or more processors are configured to: identify a first country in which the user equipment is camped; identify, based at least in part on the identified first country, a first GNSS that is preferred for use by the user equipment; generate the capability report, the capability report including an indication of preference by the user equipment for use of the first GNSS; and transmit the capability report via the one or more transmitters, to the location server, in a control plane call flow according to a long term evolution positioning protocol (LPP).

Clause 11: The user equipment of claim 10, wherein the capability report further includes a mobile country code associated with the first country in which the user equipment is camped.

Clause 12: The user equipment of claim 10, wherein the user equipment is a mobile phone, and wherein the capability report further includes at least one of or a mobile network code or a public land mobile network (PLMN) code associated with the mobile phone.

Clause 13: The user equipment of claim 12, wherein the PLMN code is stored in a subscriber identity module (SIM) card in the mobile phone.

Clause 14: The method of any one of claims 10-13, wherein the indication of preference included in the capability report is based on evaluating a compatibility for use by the mobile phone of at least one another GNSS that is available for use in the first country.

Clause 15: A location server for providing location assistance data to one or more user equipment, the location server comprising: one or more transmitters; one or more receivers; at least one memory; and one or more processors communicatively coupled with the at least one memory, the one or more processors configured to receive, via the one or more receivers, from a first user equipment, an indication of preference for use of a first global navigation satellite system (GNSS) by the first user equipment; generate, based at least in part on the indication of preference received from the first user equipment, location assistance data for use of the first GNSS by the first user equipment for performing one or more GNSS positioning operations and excluding use of other GNSS by the first user equipment for performing the one or more GNSS positioning operations; and transmit, via the one or more transmitters, to the first user equipment, the location assistance data that is focused exclusively upon the first GNSS.

Clause 16: The location server of claim 15, wherein the one or more processors are further configured to: limit, one or more location services offered to the first user equipment, based on the indication of preference received from the first user equipment for use of the first GNSS.

Clause 17: The location server of claim 16, wherein limiting the one or more location services offered to the first user equipment comprises withholding and/or disabling one or more location services associated with at least a second GNSS.

Clause 18: The location server of claim 17, wherein the first GNSS and the second GNSS are available for use by the user equipment in a first country in which the user equipment is camped.

Clause 19: The location server of either one of claim 17 or claim 18, wherein the first GNSS operates in an upper band of L1 GNSS frequencies and the second GNSS operates in a lower band of L1 GNSS frequencies.

Clause 20: The location server of any one of claims 15-19, wherein limiting the one or more location services offered to the first user equipment comprises precluding location assistance data associated with use of at least one another GNSS.

What is claimed is:

1. A method performed by a user equipment for generating and transmitting a capability report to a location server, the method comprising:
identifying a first country in which the user equipment is camped;
identifying, based at least in part on the identified first country, a first GNSS that is preferred for use by the user equipment;
generating the capability report, the capability report including an indication of preference by the user equipment for use of the first GNSS; and
transmitting the capability report to the location server in a control plane call flow according to a long term evolution positioning protocol (LPP).

2. The method of claim 1, wherein the capability report further includes a mobile country code associated with the first country in which the user equipment is camped.

3. The method of claim 1, wherein the user equipment is a mobile phone, and wherein the capability report further includes at least one of a mobile network code or a public land mobile network (PLMN) code associated with the mobile phone.

4. The method of claim 3, wherein the PLMN code is stored in a subscriber identity module (SIM) card in the mobile phone.

5. The method of claim 4, further comprising:
configuring the user equipment to use the first GNSS and to eliminate use of at least one another GNSS.

6. The method of claim 5, wherein eliminating use of the at least one another GNSS comprises disabling one or more location determination operations that use the at least one another GNSS.

7. The method of claim 4, wherein the indication of preference included in the capability report is based on evaluating a compatibility for use by the mobile phone of at least one another GNSS that is available for use in the first country.

8. The method of claim 7, wherein the first GNSS operates in an upper band of L1 GNSS frequencies and the at least one another GNSS operates in a lower band of L1 GNSS frequencies.

9. The method of claim 7, wherein evaluating the compatibility for use by the mobile phone of the at least one another GNSS is based at least in part on evaluating a capability of the mobile phone to operate upon GNSS signals provided by the at least one another GNSS.

10. A user equipment configured to generate and transmit a capability report to a location server, the user equipment comprising:
one or more transmitters;
one or more memories; and
one or more processors communicatively coupled with the one or more transmitters and the one or more memories, wherein the one or more processors are configured to:
identify a first country in which the user equipment is camped;
identify, based at least in part on the identified first country, a first GNSS that is preferred for use by the user equipment;
generate the capability report, the capability report including an indication of preference by the user equipment for use of the first GNSS; and
transmit the capability report via the one or more transmitters, to the location server, in a control plane call flow according to a long term evolution positioning protocol (LPP).

11. The user equipment of claim 10, wherein the capability report further includes a mobile country code associated with the first country in which the user equipment is camped.

12. The user equipment of claim 10, wherein the user equipment is a mobile phone, and wherein the capability report further includes at least one of a mobile network code or a public land mobile network (PLMN) code associated with the mobile phone.

13. The user equipment of claim 12, wherein the PLMN code is stored in a subscriber identity module (SIM) card in the mobile phone.

14. The user equipment of claim 13, wherein the indication of preference included in the capability report is based on evaluating a compatibility for use by the mobile phone of at least one another GNSS that is available for use in the first country.

15. A location server for providing location assistance data to one or more user equipment, the location server comprising:
one or more transmitters;
one or more receivers;
at least one memory; and
one or more processors communicatively coupled with the one or more transmitters, the one or more receivers, and the at least one memory, the one or more processors configured to:
receive, via the one or more receivers, from a first user equipment, an indication of preference for use of a first global navigation satellite system (GNSS) by the first user equipment;
generate, based at least in part on the indication of preference received from the first user equipment, location assistance data for use of the first GNSS by the first user equipment for performing one or more GNSS positioning operations and excluding use of other GNSS by the first user equipment for performing the one or more GNSS positioning operations; and
transmit, via the one or more transmitters, to the first user equipment, the location assistance data that is focused exclusively upon the first GNSS.

16. The location server of claim 15, wherein the one or more processors are further configured to:
limit, one or more location services offered to the first user equipment, based on the indication of preference received from the first user equipment for use of the first GNSS.

17. The location server of claim 16, wherein limiting the one or more location services offered to the first user equipment comprises withholding and/or disabling one or more location services associated with at least a second GNSS.

18. The location server of claim 17, wherein the first GNSS and the second GNSS are available for use by the user equipment in a first country in which the user equipment is camped.

19. The location server of claim 17, wherein the first GNSS operates in an upper band of L1 GNSS frequencies and the second GNSS operates in a lower band of L1 GNSS frequencies.

20. The location server of claim 16, wherein limiting the one or more location services offered to the first user equipment comprises precluding location assistance data associated with use of at least one another GNSS.
